(19) United States
(12) Patent Application Publication
(10) Pub. No.: US 2005/0182725 A1
(43) Pub. Date: Aug. 18, 2005

(54) Check replenishment method and process

(76) Inventor: Michael Modica, Mission Viejo, CA (US)

Correspondence Address: MICHAEL A. SHIPPEY, PH. D., 4848 LAKEVIEW AVENUE, SUITE B, YORBA LINDA, CA, 92886, US

(21) Appl. No.: 10/778,495

(22) Filed: Feb. 13, 2004

(51) Int. Cl. G06F 17/60

(52) U.S. Cl. 705/45; 705/1

(57) ABSTRACT

The present invention encompasses a method and computer-based process for automating the ordering and reordering of negotiable instruments for purposes of replenishing said instruments by means of a proactive system reliant on data present in the records of the issuing financial institution and pre-set triggering events selected by the institution and/or the account holder, and further allowing for an account holder to override the automated system when preferred.

### BACKGROUND OF THE INVENTION

1. Field of the Invention

The present invention relates to the field of banking and financial processing, and more particularly to a method and process for automating the process of ordering and reordering blank negotiable instruments, specifically checks.

2. Description of Related Art

At present, the ordering method and process for negotiable instruments, such as checks, that are used to access funds held in banks and other financial institutions requires the involvement of personal labor by an employee of the institution, the account holder, and/or an employee of the company receiving the order or reorder. Said labor may be in the form of a customer's telephone contact to request an order or reorder, which may be accomplished using an automated telephone system or a person assisted system on the part of the company receiving the order or reorder. Alternatively, said labor may involve a customer's completion and submission of an order form by a mail or courier service, by electronic means such as through a computer network system, or by facsimile. It is also possible that an employee of an institution may commence the order or reorder process by these same methods at the request of an account holder.

One disadvantage of the present check order and reorder method and process is that it is reactive. That is, the account holder must take action before checks will be ordered or reordered for said person's use. At the least, this situation creates an inconvenience for the account holder. If an account holder forgets or otherwise fails to take action before running out of checks, the result can be more than a mere inconvenience because the account holder may be unable to gain easy access to account funds until new checks are printed and transmitted to the account holder. While check printing companies typically include reorder forms as part of the checks delivered to account holders, use of said reorder forms still requires the account holders to take assertive action, assuming the account holders have not lost or thrown away said order forms over the period of time required for depletion of the checks.

The current reactive system has the further disadvantage of multiplying needlessly the paperwork, as well as increasing the cost, associated with check ordering and reordering. First, an order or reorder form must be completed, a process often done on paper although electronic orders and reorders over a computer network are also now available. Completion of a paper or electronic order or reorder form requires the person completing said form to spend time obtaining the necessary information and filling out the form. Next, when an order or reorder form is received, regardless of the mode used to submit it, the information on that form must be reviewed and confirmed for accuracy and transferred to a mode for printing, again requiring employee labor and processing delays. Finally, if inaccuracies are found in the information submitted, the check printing company typically reverts to the account holder to correct the deficiency, resulting in further delays and often conducted by an exchange of letters, forms, or other paperwork. There is a need for an automated method and process by which the ordering and reordering of checks can be accomplished without depending on submission of a request by or for the account holder.

### BRIEF SUMMARY OF THE INVENTION

The present invention relates to a method and process by which check ordering and reordering is automated using information that is pre-set in the system. When said information is violated, the system triggers an event, namely the printing and provision of an order of checks to the account holder. In addition, the system would allow for orders or reorders to be initiated by the account holder as well as by the triggering event in case a situation arises that is not anticipated by the pre-set information in the system.

The information used as a trigger can include any proactive action or indicator that a financial institution could utilize to give rise to an assumption that a customer may need an order or reorder of checks. Information that the system might rely on to trigger said event could include, as an illustration, the attainment of a specified check number for a particular account. As another example, a trigger could be based on the rate at which an account holder uses checks (known as “the burn rate”). Another trigger could be the initialization of an account, and yet another might be modification of an account holder's name, address, or other such information. The trigger information that is utilized would depend on such factors as the type of account, the policies and practices of the particular financial institution, and possibly governmental regulation. It might further be appropriate to take into consideration a choice allowed to the account holder and stored as part of that account holder's records.

An object of the present invention is to provide a method and process for automated check ordering and reordering that is proactive to the financial institution issuing the checks and thereby offers more convenience to account holders.

Another object of the present invention is to reduce the costs and delays associated with the paper and electronic processing of check order and reorder forms by using data already present in the records for account holders to generate printed checks, eliminating the need for reviewing and confirming the accuracy of said data.

Yet another object of the present invention is to reduce the number of rush print jobs and the periods during which accounts are inaccessible to account holders because they fail to submit completed check order or reorder forms.

A further object of the present invention is to allow account holders a reactive alternative to the automated system if they should select to submit a check order or reorder rather than wait for a trigger event by the financial institution or if they should choose to opt out of the automated system.

### BRIEF DESCRIPTION OF THE DRAWINGS

FIG. 1 is a flowchart that illustrates the components of the system of the present invention.

FIG. 2 is a flowchart that illustrates the process of the present invention.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

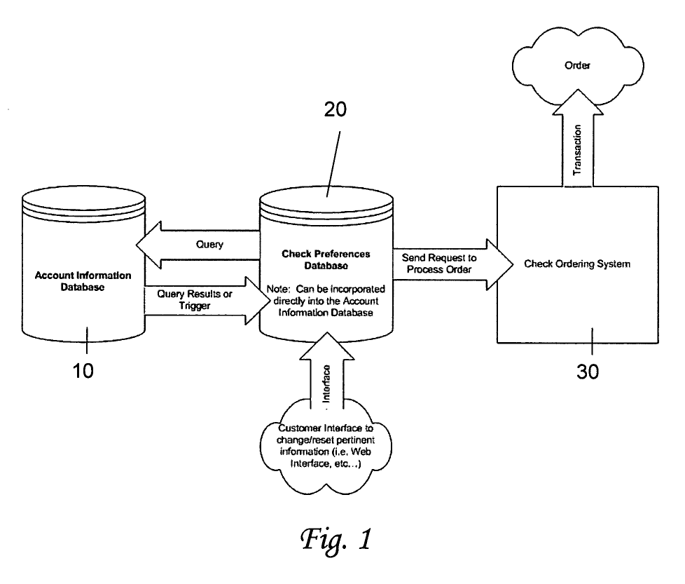

FIG. 1 is a flowchart that illustrates the components of the system of the present invention. The invention has a back-end computer system that contains software, referred to here as “Account Information Database.” This software receives and stores data related to the account holder and the account 10. At a minimum, such data would include the account number, type of account, account holder's name, address, and other personal information, account balance, transaction history, and debts and credits posted to the account. The computer system used to receive, transmit, and store said data may be in the form of a mainframe computer, but other alternatives are also available. The computer system utilized, both in terms of hardware and software, is dependent on the selection made by the financial institution, which selection is further dependent on factors specific to the financial institution. For example, some institutions may develop their own proprietary software for these purposes, while others may employ software available in the general public market, such as a relational database product (DB2, Oracle, MSSQL Server, and the like).

The Account Information Database contains all necessary data for the ordering and reordering of checks. Thus, it stores all account holder data that is displayed on a check, the numbers of checks that have cleared, dates for said checks, and the like.

The information contained in the Account Information Database will be utilized when an order or reorder is triggered by a pre-set event. Pre-set events are determined by data stored in a Check Preferences Database 20. This Database drives the order and reorder system. For each action that occurs to the records of an account holder, the Check Preferences Database will analyze the check information received and stored in the back-end system. This information will be compared to the triggering event stored in the Check Preferences Database, and when the information is found to be violated, an order or reorder will be automatically submitted for printing without any reactive request by the account holder. The Check Preferences Database may be developed as a stand-alone system or it may be incorporated into the Account Information Database.

The Check Preferences Database may pull or push the needed information from the Account Information Database. “Pulling” the information refers to a process by which the Check Preferences Database queries the Account Information Database and extracts the latest check information. For example, the Check Preferences Database may transmit a message that requests information using a particular account number and then receive from the Account Information Database one or more numbers of the most recently cleared checks. “Pushing” refers to a process by which the Check Preferences Database receives data from the Account Information Database based on pre-programmed events. For example, data may be transmitted, or “pushed,” for every fifth check that is processed or at the end of each business day. In other words, the distinction between the “push” and the “pull” processes is which database is driving the process for transferring the information to the Check Preferences Database.

The third component of the present invention is a Check Ordering System 30. It is this System that will place the actual check order with the printer once a triggering event has occurred as determined by the Check Preferences Database. This System can be any of a variety of Systems currently in use by particular institutions.

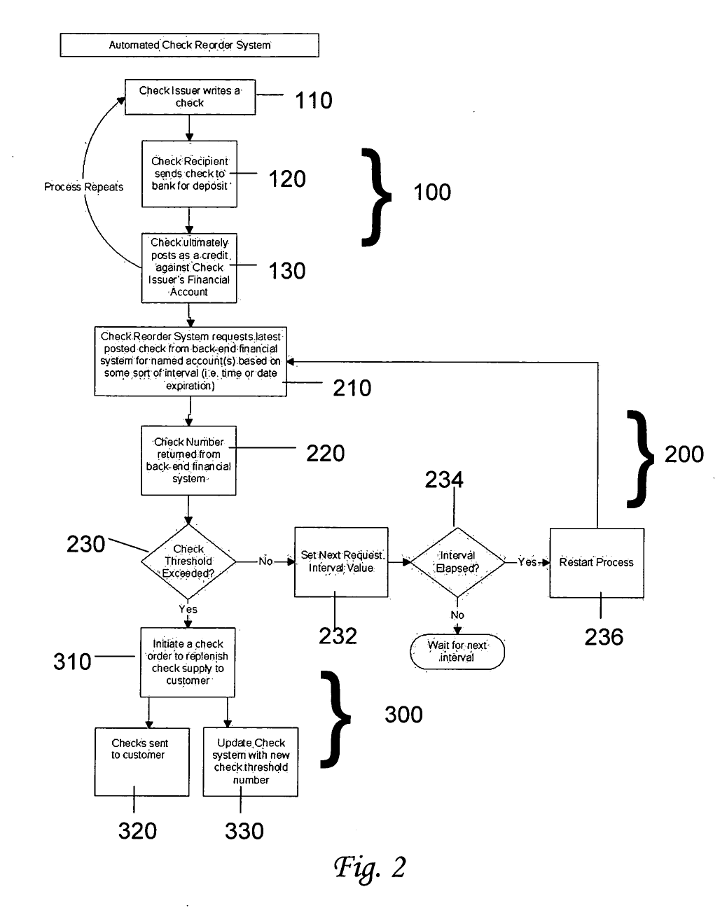

FIG. 2 is a flowchart that illustrates a preferred embodiment of the present invention. The flowchart may be divided into three primary sections. First, check transactions are made by the account holder and processed 100. Second, the Check Preferences Database periodically analyzes the data being received and stored in the first section 200. Third, a check order or reorder is initiated 300.

In the first section 100, an account holder writes checks repeatedly to access funds held in the account 110. Each recipient of such a check returns it to the financial institution for deposit of the payment 120. The check is then processed by the financial institution, credited against the Check Issuer's Account, and the funds are withdrawn from the account 130. This process can repeat without limit, provided the account holder has enough checks. The data obtained in this process is stored in an Account Information Database (see FIG. 1).

In the second section 200, the Check Preferences Database (see FIG. 1) is utilized to review data from the Account Information Database at periodic intervals that have been pre-programmed in compliance with government regulations and/or the policies and practices of the financial institution 210. Such an interval may be the expiration of a particular date or time or the use of a certain check number 220. If the data received at the pre-set interval is compared to the pre-set trigger event and returns a negative, the process will repeat until the event is triggered 230. To repeat the process, the system will set a new interval indicator 232 and compare data stored in the Check Preferences Database to the new interval 234. If a negative is received, the System will continue to wait until the next interval and will compare the data received to the trigger event. If a positive is received, the System will repeat the process of requesting data from the Check Preferences Database for analysis of triggering events 236.

In the third section 300, the Check Preferences Database has determined that a triggering event has occurred and it transmits a message to the Check Ordering System to secure the necessary data from the Account Information Database and order or reorder the printing of the checks 310. Once the order or reorder information is submitted, the checks for the account holder are replenished 320. The Check Ordering System then transmits a request to the Check Preferences Database to replace the triggering event with the next triggering event 330.

While embodiments of the present invention have been shown and described, various 15 modifications may be made without departing from the spirit and scope of the present invention; and all such modifications and equivalents are intended to be covered within the instant patent. Therefore, the entire scope of the present invention should be determined by the appended claims and their legal equivalents, rather than by the given examples.

1. A check reordering system, comprising:
means for requesting, receiving, and accurately assessing the latest posted check from a named account in a financial institution;
means for comparing the check number from said latest posted check against a predetermined maximum check number threshold;
means for initiating an automatic check reorder to replenish the check supply, in the event the threshold is exceeded;
means to debit the named account for the cost of the reordered checks; and,
means for restarting the system with a new threshold after the check reorder.

2. The check reordering system of claim 1 wherein the entire system is automated to run on a computer system.

3. The check reordering system of claim 1 wherein said system is part of the check processing system of said financial institution.

4. The check reordering system of claim 1, further comprising a timer for regulating the number of requests posted by the system.

5. A computer system for the reordering of bank checks, comprising:
An iterative routine which comprises the following steps:
1) Requesting the check number of the latest check;
2) Receiving said latest check number;
3) Comparing said latest check number to a threshold value;
4) Choosing a first pathway if the threshold value is exceeded, and a second pathway if the threshold value is not exceeded.

6. The computer system of claim 5, wherein said first pathway comprises the following steps:
a. Initiating an automatic check reorder to replenish check supply;
b. Updating the system with a new threshold value; and,
c. Rejoining said iterative pathway at step 1.

7. The computer system of claim 5, wherein said second pathway comprises the following steps:
a. Setting the next request time;
b. Evaluating the time; and
c. Rejoining said iterative pathway at step 1).

8. The computer system of claim 5, further comprising a timer for regulating the number of requests posted by the system.

9. The method of automatic reordering of checks, using the check reordering system of claim 1.

10. The method of automatic reordering of checks, using the computer system of claim 5.
